(19) United States
(12) Patent Application Publication
(10) Pub. No.: US 2013/0272514 A1
(43) Pub. Date: Oct. 17, 2013

(54) One-click methods and systems for establishing a voice connection with a live person

(71) Applicant: Aaron Michael Dragushan, Flagstaff, AZ (US)

(72) Inventor: Aaron Michael Dragushan, Flagstaff, AZ (US)

(21) Appl. No.: 13/648,278

(22) Filed: Oct. 9, 2012

Related U.S. Application Data
(60) Provisional application No. 61/543,948, filed on Oct. 6, 2011.

(51) Int. Cl. H04M 3/42

(52) U.S. Cl. CPC H04M 3/42195
USPC 379/210.01

(57) ABSTRACT

A one-click method for establishing a voice connection.

This application claims the benefit of U.S. Provisional Application No. 61/543,948 filed on Oct. 6, 2011 which is hereby incorporated by reference.

### BACKGROUND

Contacting a customer service representative of a company can be frustrating to a caller. The caller frequently must wait on hold for extended periods of time and may have to navigate phone trees. Thus, there is a need for a one-click method and system for establishing a voice connection with a live person without waiting on hold.

### SUMMARY

A one-click method for contacting a person comprising the steps of selecting a company; and receiving a call from the company.

### BRIEF DESCRIPTION OF THE DRAWINGS

FIG. 1 shows a one-click method for establishing a voice connection with a live person without waiting on hold.

FIG. 2 shows a method of adding a company to the database of FIG. 1.

FIG. 3 shows a method for registering a caller.

FIG. 4 illustrates an exemplary mobile device architecture.

FIG. 5 shows a system for contacting a CSR.

FIGS. 6-13 show screenshots of one-click contacting of a CSR.

### DETAILED DESCRIPTION

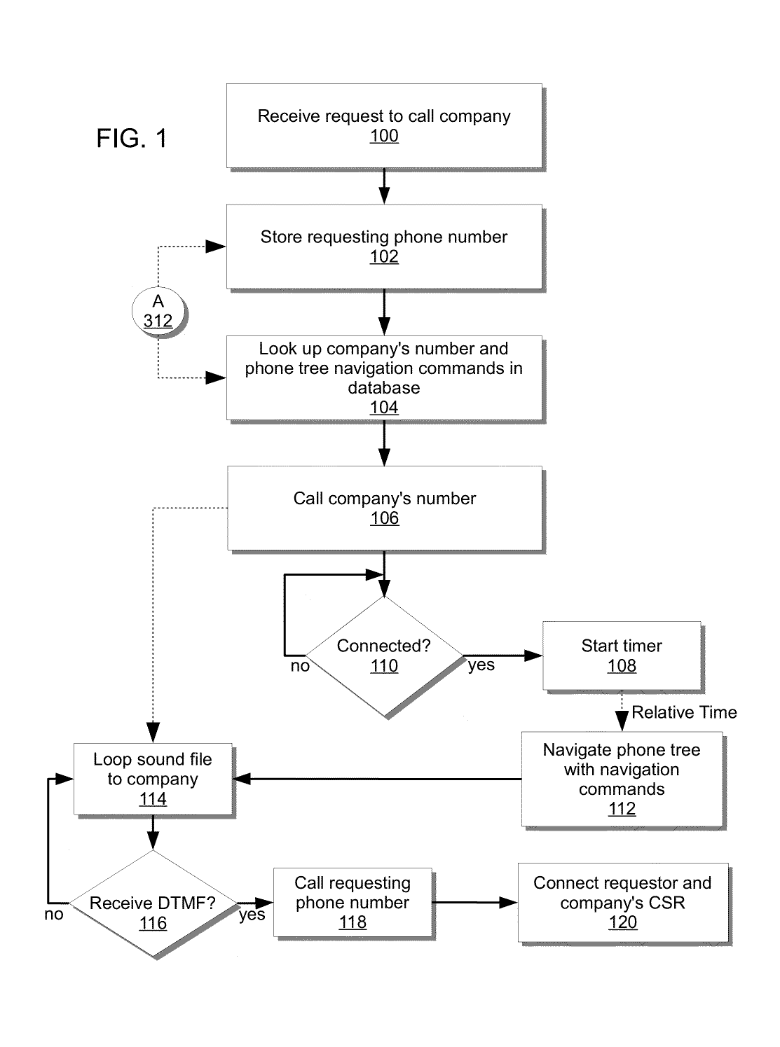

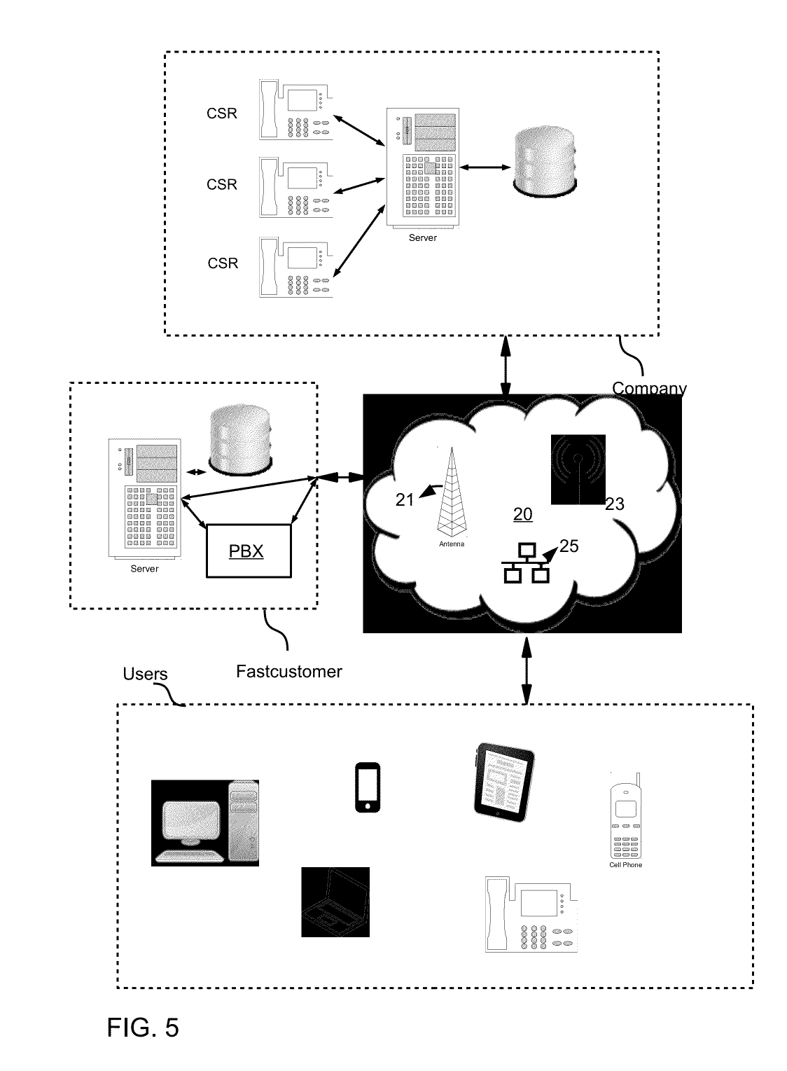

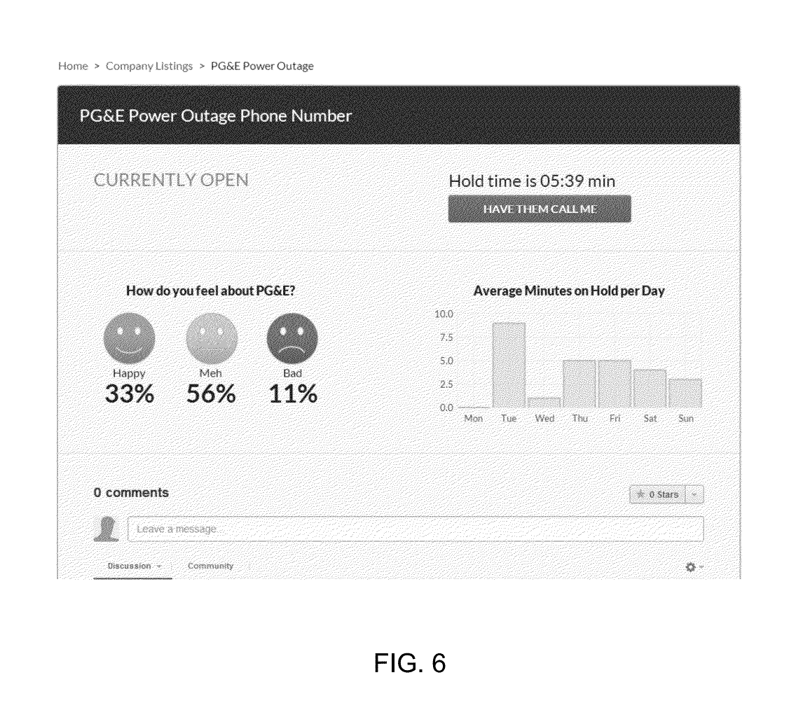

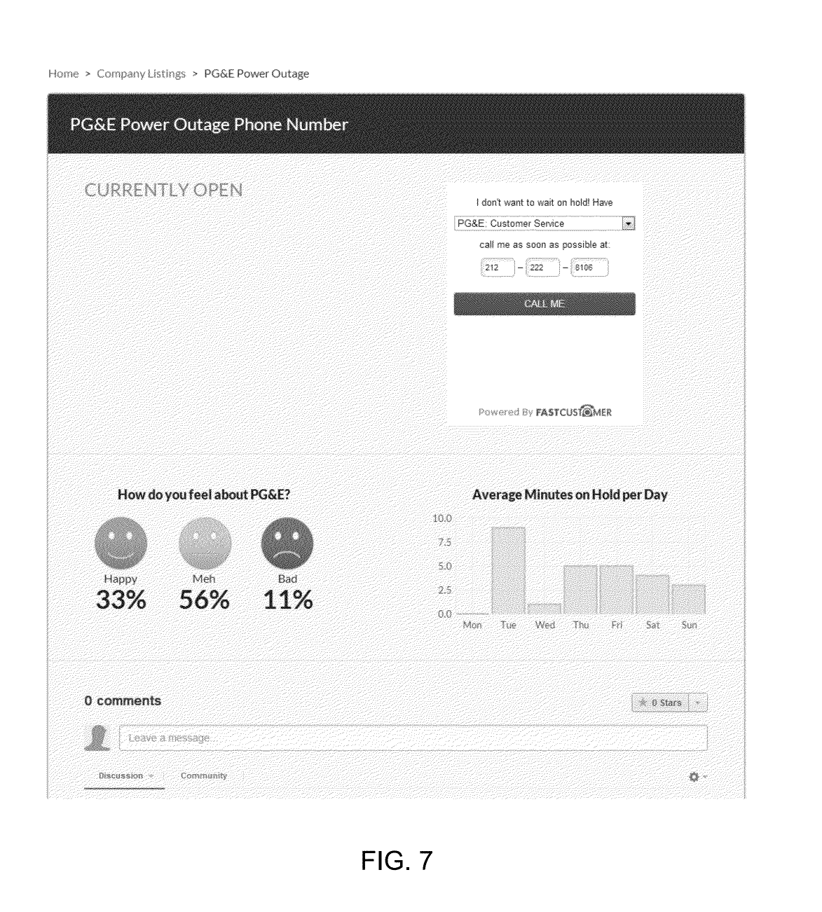

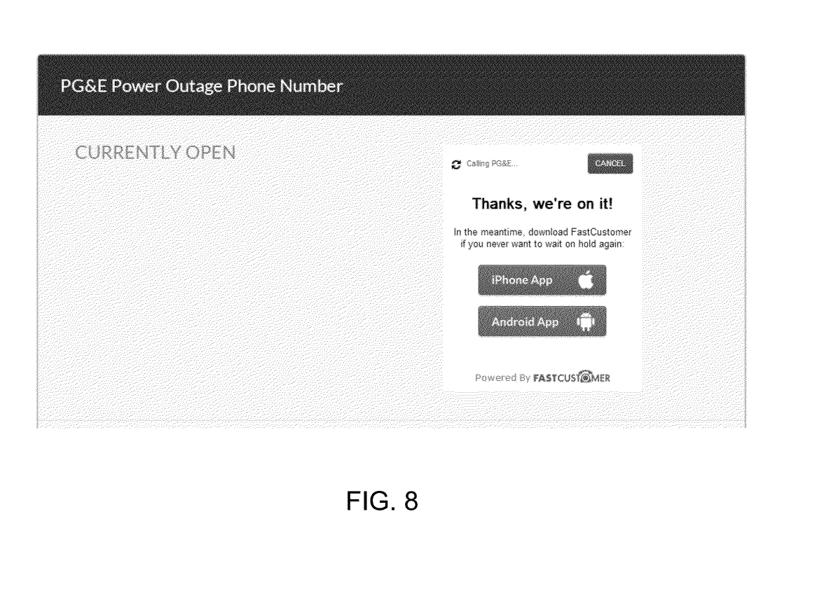

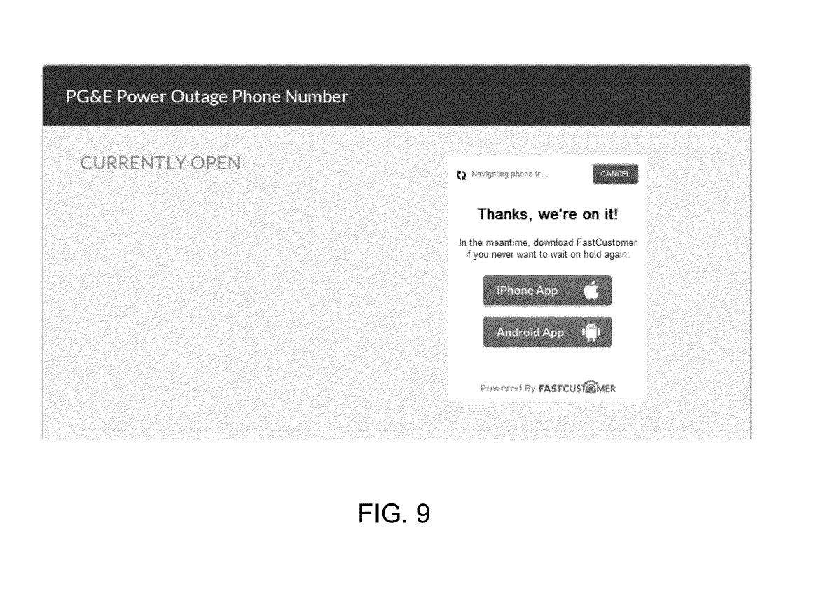

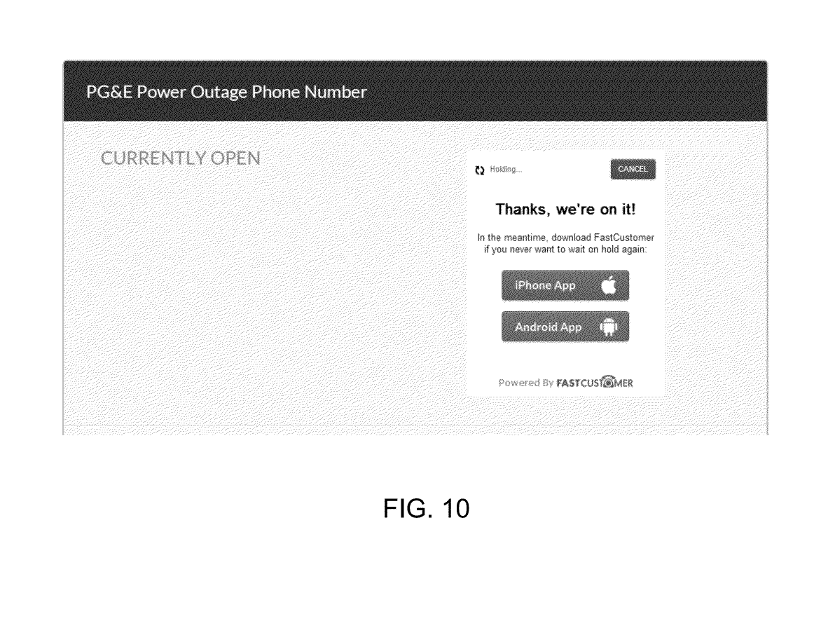

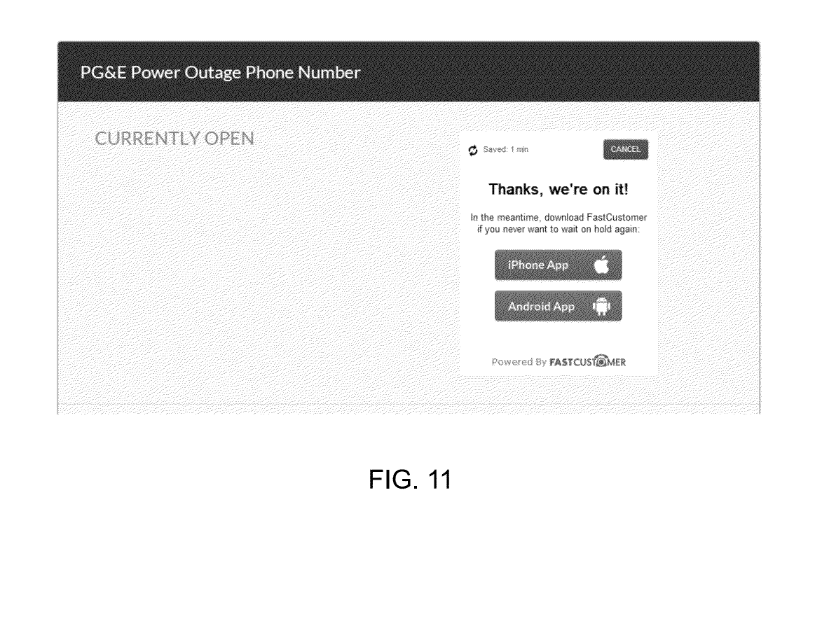

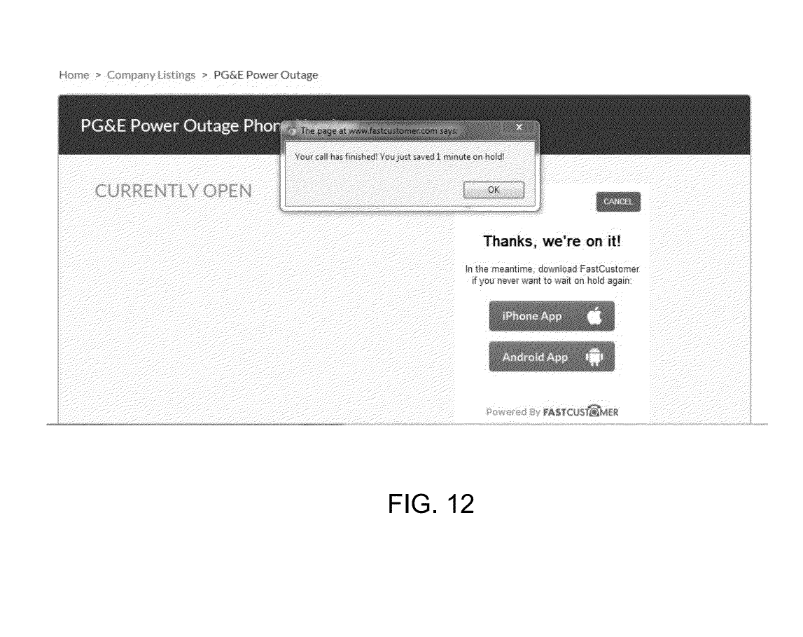

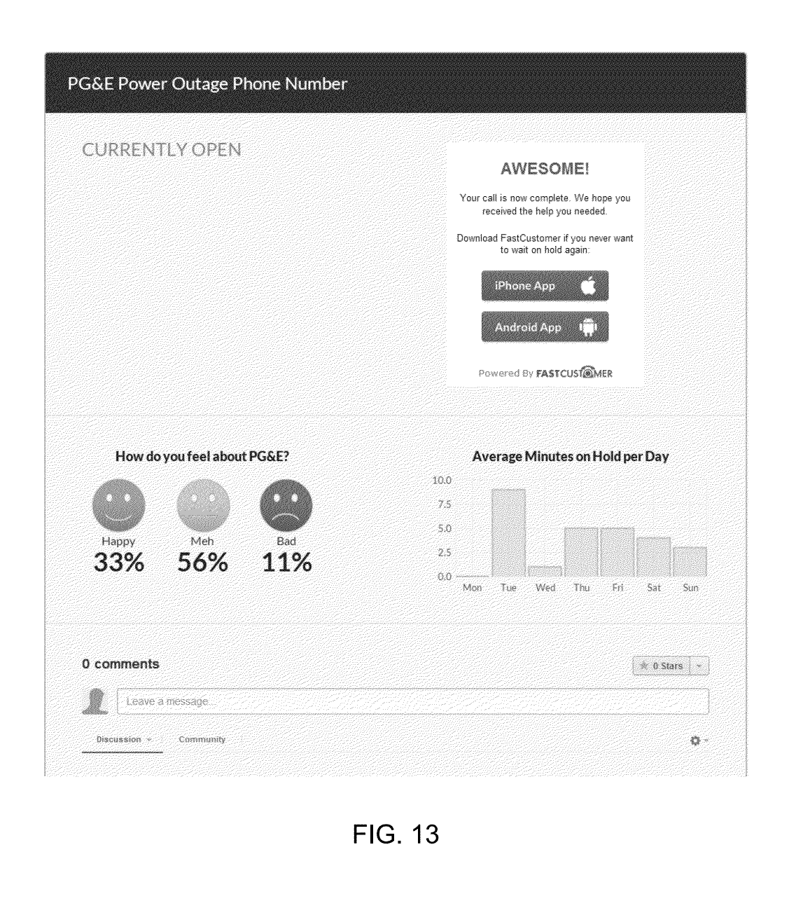

FIG. 1 shows a method to reach a live person, such as a customer service representative (CSR), without waiting on hold. FIG. 5 shows a system for contacting a CSR. FIGS. 6-13 show screenshots of one-click contacting of a CSR.

The method may help companies and individuals improve their customer service experience. A request is received 100 at a server to a call a company, for example to speak with a particular group, representative, or person at an organization, such as a customer service representative. The request 100 may also be to call a person selling or offering some product or service speak, whether or not that person is associated with or works for an organization. The request 100 is made by a user, that is, someone who wants to speak with another person.

An application (e.g. software) is installed on the user's mobile device, such as an iPhone, Android phone, or other device. The application may equivalently be installed on a computer as a program, a web browser plugin or extension, a plugin or extension to another program, and the like. The application sends data to a server, receives data from the server, and causes information to be displayed on a screen of the mobile device (or, more generally, the computing device).

The application receives a list of organizations, each of which can be called. The list of organizations and data associated with the each organizations, for example telephone number, organization name, phone tree navigation commands, and the like is stored in a database in communication with the server. The server receives a request from the application to query the database of organizations, and transmit the list of organizations to the mobile device, where it is displayed. It is understood that by “transmit the list” it is meant that data is communicated to the application which causes one or more of the organization names or other identifier (such as a logo) to be displayed on the screen of the computing device. Accordingly, transmitting a list may mean, alone and in combination, transmitting the names and other data for display, transmitting the names and other data for local storage on the computing device, transmitting a command to access local storage or modify local storage in some way, and any other way to communicate and display information. In one example, the list of organizations includes a plurality of companies. In another example, the list of organizations has only one organization, such as in the case of dedicated use of the application a company's website.

A user “clicks a button” of the mobile device to call an organization. By “click a button” it is understood that the button may be virtual, as in a graphical icon on a touchscreen. For example, the name of each organization is displayed, in a scrollable or searchable manner, on the screen of the mobile device. A user selects one of the organizations by touching the icon of name of the organization. In another example, if the display is through a web browser of a computer, the user selects the organization by clicking the mouse cursor on the organization name.

When the user selects an organization, a request to call the organization is sent from the application and received 100 by the server. At this time, from the perspective of the user, they do not have to take any more action; the user may put away his phone, use it for other purposes, and the like. Similarly, if the request is made from a computer such as a laptop computer or desktop computer, the user does not have to take any more action; the user can browse to other sites, play games, turn the computer off, and so forth.

As will be described with reference to FIG. 1, when a person in the user selected organization is available and on the line, the server will call the user's mobile phone number and, upon answering, the user and the organization will be connected.

At step 102, the requester's phone number is stored 102 so that it can be called at a later time, that is, the user is identified in some way. Storing the number 102 more generally includes storing any electronic identifier that can be used to identify or contact a user. For example, the telephone number of the user may have been previously stored, in which case storing the number 102 accesses the user data.

The database is queried 104 to obtain the telephone number of the organization and any phone tree navigation commands that should be “played” in order to navigate the organization's phone tree. For example, commands may include DTMF tones, the duration of the tones, the timing of tones relative to the start of the call (or equivalent), as well as pauses, durations of pauses, and the timing of the pauses relative to the start of the call (or equivalent). Other commands may include voice commands to navigate an interactive voice response (IVR) system.

The number of the organization is called 106 and a timer is started 108. It is well understood by those having ordinary skill in the art how to initiate, maintain, and transfer a call from a server over a network to a device, such as a telephone network to a telephone. For example, the server may run a software public branch exchange (PBX) such as Asterisk. The network may include one or more networks, for example the Public Switched Telephone Network (PSTN), a packet-switched network for example, Voice over Internet Protocol (VoIP) connections, an Integrated Services Digital Network (ISDN), the internet, a mobile telephone network or any combination of these. Various signaling protocols may include VoIP connections including, without limitation, a Session Initiation Protocol (SIP), an Inter-Asterisk Exchange (IAX) protocol, H.323 protocol, and the like.

The call is made 106 and the server begins to loop a sound file 114. The sound file is played continuously 114 until a live person at the organization is reached 116. The sound file(s) are stored in the database. One example of a sound file is the sound of a telephone ringing. Another example of a sound file is audio that repeats, for example, “Please press 1 to speak with the next customer.” These or other equivalent sound files may be prerecorded, preselected, and otherwise designed and chosen according the variables such as the time of day, the organization's name, geography, language, and so forth. Accordingly, there may be multiple sound files.

It is well known that upon calling an organization, a person rarely answer the phone. Instead, the caller is usually greeted by an IVR system. So, in step 112, when the call is answered by the organization's IVR system, the phone tree is navigated 112. The navigation commands, such as DTMF tones and periods of silence, are transmitted from the server according to the navigation command information stored in the databases so that they are received by at the organization. This causes the organizations phone tree to be navigated as if a live caller were navigating it.

Eventually, after navigation 112, which may include doing nothing (in which case the command can be referred to as a pause), a person at the organization, such as a CSR, answers the call. Upon answering the call, the organization's representative hears the audio from the sound file 114 being transmitted by the server over the phone line, for example, “Please press 1 to speak with the next customer.”

More often than not, the representative presses “1” or carries out whatever action they hear requested 116. This may include speaking or repeating an audio command. The server waits to receive the “1” DTMF 116 or any other response commensurate with the audio request 114.

The reception of the “1” tone or other command indicates that a human (e.g. CSR) has answered the call, and the command serves as a signal to the server (including the software executed by the microprocessor of the server) to contact the user 118 who made the request and transfer the call so that the user and the representative are connected 120.

Once the CSR has been reached 116, the server calls the telephone number of the requester 118. During this time the CSR may hear the call ringing until the user answers the call, or the server may mute the ringing, or play music, or any other sound.

In one example the server connects the user and the representative prior to the user answering the phone. In another example, the server connects the user line and the company representative's line only once the user answers the call. In any case, the two people are connected to each other and may carry out a conversation. In this way, the user does not wait on hold to contact another person, such as a CSR. The user simply causes an application to signal a server to contact a desired company by selecting the company (with a touch screen, a mouse, and the like). Once the server has established a connection to a live person, the server contacts the user and connects the two parties.

It is noted that the sound file may be played after the (DTMF) phone tree navigation or at any time so that it is heard by the representative when they answer the call. In an alternate configuration, the looping sound file may be replaced or combined with any method for detecting whether a person or a machine has answered the call. Thus, more generally, steps 114 and 116 can be understood to include any method for determining when a human has answered a phone call.

As disclosed above, steps 114 and 116 play a sound file that includes some command so that when a live person answers the call, the person hears the command and responds as directed, the response providing a signal that a person has answered the call. In an alternate embodiment, the sound energy or length of the answer is measured. Typically, a live human answers with a short statement such as “Hello, how may I help you?” whereas a machine answers with a longer statement such as “Thank you for calling. Your call is very important to us. Please stay on the line and a representative will be with you shortly”. Those skilled in the art will appreciate that many methods for differentiating machines and humans may employed, alone and in combination.

As disclosed above, after the agent presses a key (for example, “1”), the server plays the recording 114 to the agent. In another example, an agent types in a unique identifying number so that the server can identify the particular call with the agent. An API could also be used to correlate agents with the calls. In this way, the work and performance of agents can be stored and evaluated, records can be kept of all calls, and reports generated.

Even though phone numbers are typically associated with a POTS, it is understood that the methods and systems herein may “call” any electronic device having an electronic identifier. In this way, for example, the methods and systems are entirely compatible with contacting individuals and organizations by way of any computer or computing device, such as, for example with VoIP, Skype, Google Voice, IM, and the like. Also, the methods and systems may be embedded in any device, such as a television, refrigerator, automobile, or other device or product so that a user of the device can contact the company for technical support, sales, or any other type of help or guidance. The database may be local to the embedded device, remote and accessible via the internet, or combinations thereof. The application and database may be automatically updated without input from the user.

Other modifications are possible. Depending on security preferences set by the server's administrator and/or the user, after the agent presses the key, the phone number of the user (stored in 102) may be detected or obtained from the user's phone or computer.

The system can be configured to handle multiple calls and operated so as to make the most of the server's resources and information about when calls are most likely to be successful. The calls can be placed or queued based on a set time or other metrics. For example, the calls could be about 33 seconds apart. The system may be configured so that one user places multiple calls to the same company. For example, if a first agent disconnects or does not press the key, the next call in the queue is used to contact another agent working at the company.

Ratings and performance data may be request and received by the server. For example, after the call is completed, the user may be requested (e.g. on the display of the device) to enter a rating for the call. The rating may comprise information related to the agent, quality of the call, satisfaction, and the like. Such ratings can be entered via a user interface of the application.

Reports may be created. A report can be generated from a plurality of ratings. The report can be transmitted or otherwise used by a company to assess and improve call center operations. The report may include information about call volume, agents, ratings from callers, and the like.

A measure of recent call volume and/or call volume patterns (including hold times) can be generated based on a plurality of user calls. A prediction of future call volumes can then be made and the server's outbound call times grouped, timed, or queued for more favorable results, server operations, cost efficiencies, and the like.

Based on the prediction, calls can be placed to companies in advance of their actual need. In one example, the amount of time between placing a call and an operator's response is estimated, for example by taking an average of call wait times or by any other statistical or probabilistic method. A second call is then placed based on the estimation. Information obtained from the second call can then be used to update and improve the estimation.

Based on the estimation, a plurality of calls can be placed preemptively, before any user request to contact a particular organization. For example, calls could be placed in the queue for the calls made to an organization in anticipation of users making such calls in short order. Thus, when a user requests a call, one of the already placed calls is connected with the user's request so that when it is answered, the user is contacted. In this way, much of the delay between when a user requests a call and receives a call from the server is reduced from the perspective of the user. One example is, if the current call volume is 10 requests for calls per minute for AT&T, and that hold time is around 700 seconds, 10 calls can be placed to the company every minute.

As disclosed above, some of the variables and procedures executed by the server to place, schedule, queue, time, and modify the calls include:

$SecondsFromRequestToCall = how long in seconds between when a
customer requests a call and their phone rings.
$CallingRate = # of seconds between calls we place for one specific
company
$EmptyCalls = # of times in the last X minutes that an operator hit 1 to
connect to a customer and we had no customer who wanted that call. In
other words we are placing too many calls.
$HoldTime = # of seconds we expect to wait from the start of a call
until an operator indicates that they're ready.
$SecondsAlive = # of seconds a call has been alive for. So if we start
a call into a company and that call is 20 seconds old, $SecondsAlive = 20.
Call Volume Adjustment: Every X minutes run this check:
// this adjusts how often we're placing calls so we adjust to the
company's call volume as it goes up or down over the day. This algorithm
should ramp up call volume automatically over the day as needed.
{
If ($SecondsFromRequestToCall >= 30) CallingRate(.9);
// So if we're taking too long for customers, decrease the # of seconds
between calls, so calls are happening more frequently.
If ($EmptyCalls >= 1) CallingRate(1.1);
}
If ($SecondsAlive/$HoldTime > .95) $NukeCall( );
// We don't want operators to have a bad experience with us; if they do
they might start rejecting our calls. To prevent this, we'll kill off
calls that get too close to being answered if we don't have someone
waiting for that call.

These and other parameters can be employed alone and in combination to adjust parameters related to calls. For example, if the SecondsFromRequestToCall is greater or equal to 30 seconds, the CallingRate can be decreased by 10%. If there is a significant time lag between connecting calls, the number of seconds between calls can be decreased. Or, for example, if the SecondsFromRequestToCall is less than 1 minute, the CallingRate can be increased by 10%. If, for example, the ratio of the SecondsAlive and HoldTime variable is more than 0.95 the call could be canceled. The calls could be canceled before any agent answers the calls.

Still more modification may be made. The system can be customized on a per user basis. For example, when the user requests a call, a sequence of calls for the particular user can be made to the company. The system can also be configured for specific companies. For example, the system can be configured to not place more than one call per user for a company that receives five calls per day. The system can also be configured to work with a plurality of users calling a particular company. For example, the users could be placed in a queue on the system. Then, when the agent accepts a call, the user at the top of queue is connected to the user.

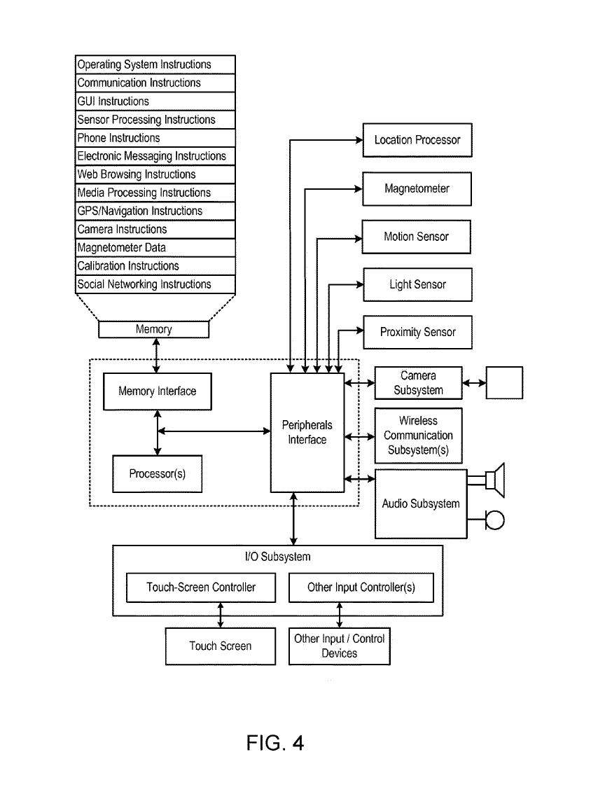

An application that contacts the server can be embedded in applications and devices on a computing device of the user (for example, a smartphone). One example of a such a computing device is shown in FIG. 4. The application can be configured to display a pop-up graphic or graphical icon when the user access a company that the system is capable of calling.

The application can be in the form of a plugin with or without a local database that associates companies with URLs and phone numbers. The local database can be updated as companies are added. The phone numbers can then be provided when the customers visit a website. And, a user can make a request (10 of FIG. 1) by clicking on an link on company's web page.

Further to the browser plugin, the plugin helps a user to contact customer service wherever they might want it, without requiring them to remember any particular website, phone, or phone number. Some additional features related to the web browser include:

a) Push-Down Bar

When triggered, the top of the browser is pushed down (see http://HelloBar.com for example) and an area at the top of the browser is displayed where for interaction with the user such as displaying a button to have customer service call them along with other things like “request a company”, settings, etc. The push-down may be automatically triggered by the URL of the site being accessed.

b) In-Page Modifications including,

If someone searches for ATT (for example), modify the search results to display a “Have someone call me” button; and if a web page includes a toll-free number, modify that text to make it a special link, or add variable text or an image nearby.

So, the push down bar can display an area that allows the system to interact with the user. The push down bar can display fields and widgets, such as a button that allows a call to be placed to the company. Other fields that can be displayed are buttons that allow a user to request a company and/or adjust settings. A URL could trigger the display of the push-down bar. Modifications to the display can be made. For example, if the application detects that a search has been made for a particular organization, the search results can be modified to display a “Have someone call me” button. If a web page includes a toll-free number, the text displaying the number could be converted into a link, a variable text could be placed in the display, or an image could be placed in the display.

The system can also communicate to the user by the application. For example, If the user requests to communicate with a company (e.g., by going to the website of the company) and a toll-free number associated with the company is in the database, a message such as “Have someone call me,” could be displayed. If the number is not in the database, a message such as, “Add this number to FastCustomer” could be displayed. If the number is in the database, but is unavailable for calling, nothing could be displayed.

Outbound calls can be monitored, for example, by executing a query on a local database of the mobile device. In this example, when an outbound call matches a number in a server database, a message that displays, “Would you like FastCustomer to have this company call you?” is displayed. Buttons (e.g., a YES or NO button) requesting that allow for user interaction could also be displayed.

The user can also request, through the application, that a company be added to the database. After a request is received, the system attempts to add the company number to the database. A live user could call the company or a variety of combinations could be automatically entered by the system (e.g. doing nothing and seeing if an operator is reached, or pressing 0, 0, 0, or pressing #, #, #, #, and the like).

Once an agent is located, a message requesting that the agent press a key can be sent to the user. Once the agent presses the key, the number and route through the phone tree is added to the database. The user can then be contacted and notified that the company has been added to the database.

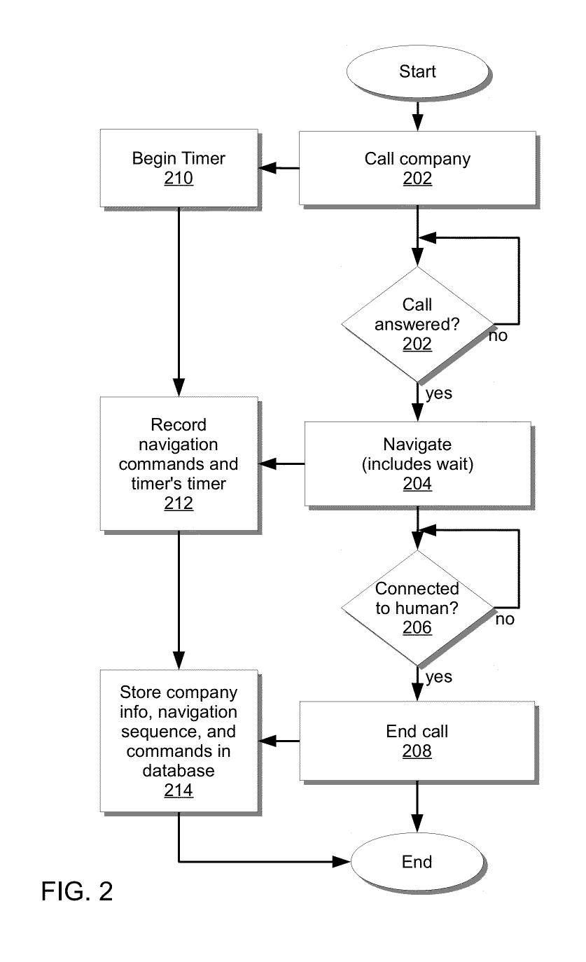

FIG. 2 shows one method of adding a company to the database used in FIG. 1 above. At step 200, the company is called by a person. A timer is started 210 so that navigation commands can include relative times, durations, and the like. When the call is answered 202, the user navigates 204 the phone tree. Navigation, such as DTMF tones and pauses, are stored 212 along with relative timing and durations. The navigation 204 continues 206 until a human operator picks up the call 208, at which point the navigation 204 was successful. The company information, navigation commands, and sequences are stored 214 in the database.

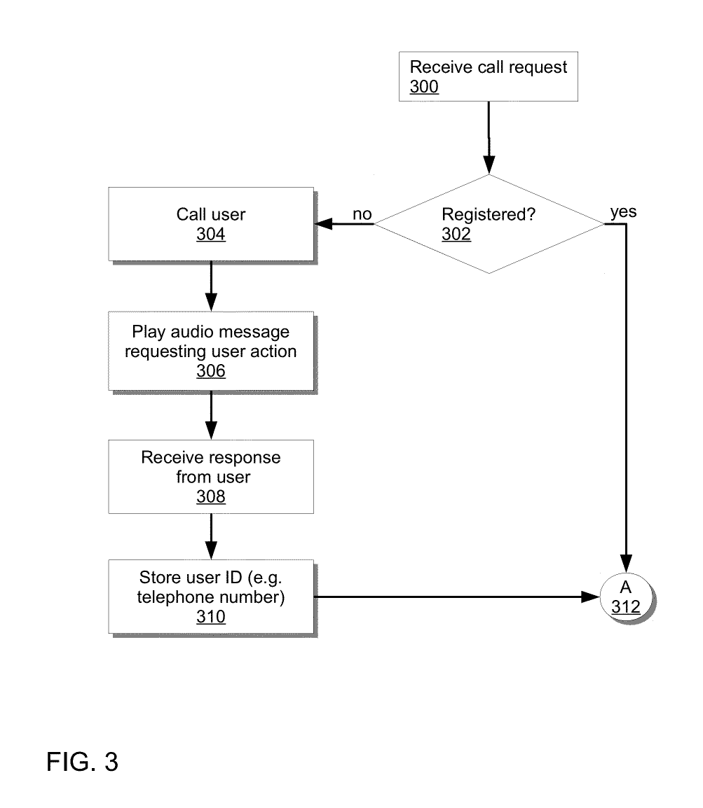

FIG. 3 shows a method for registering a caller. If implemented, FIG. 3 is a method carried out in step 100 of FIG. 1. A call request is received 300. If the user is not registered (NO branch), that is the user's telephone number is not in the database, the user is called 304 some time after the request is received 300. When the user answers the call, audio is played 306 by the server requesting the user to take some action, such as pressing the number “1” or entering a sequence of numbers or saying something (in which case the server includes a voice recognition module). The user responds to the request and the response is received by the server 308. Then, the user identifier, for example the telephone number is stored 310 in the database. The method of FIG. 1 may continue at step 102 or 104, depending on the particular implementation.

With the above disclosure in mind, it is now appreciated that while reference is made to calling an operator at an organization, the methods and systems disclosed herein may be used to contact any individual. In one example, individuals can add themselves (which may include an approval process) and the services they offer to the database. Additional data may include location information. The request is made by a user to contact the individual (step 100 of FIG. 1) as described above. If individual being contacted answers the call (generally reflected in steps 114 and 116 of FIG. 1), the requester is called (118 of FIG. 1) and the two parties are connected (120). If the individual being called misses the call, the server may call again at a later time. If the individual has the application on his phone or computer, the application displays a message/icon such as “Missed Call” that when pressed contacts the server thereby signaling the server that the individual is available (this is most generally equivalent to step 116 of FIG. 1). Thereafter, the requester is contacted (118 of FIG. 1) and the two parties are connected (120 of FIG. 1).

Note that the user who pressed the button to be connected to the service provider is not aware that the service provider missed the original call and clicked on the application they would rather connect later. The user's experience is that they clicked a button and the service provider called them back. In this way, the application empowers a user to simply click a button (which also includes a link) indicating that they need a service.

If location information (such as GPS) is available, the server simultaneously calls multiple service providers, navigates their systems and play a recording to each person/agent (see FIG. 1). The first agent to press 1 is selected and connected with the customer. Users can rate their experience with the service provider, and poorly rated companies can be pruned from the database. In one example, this is implemented so as to get a taxi quickly from a good company, wherever the user is located.

Other modifications may include associating variables with users. For example,

Within the system, users are requested to take tests (e.g. technical) or based on how much they have helped other users with questions. External data sources can be accessed. A name, email address, or phone number can be used to automatically search an external data source and receive additional data about a user such as social networking account information, for example, a Twitter account, Facebook account or Klout score.

Calls can be handled in various ways according to these variables. Users can be identified by their phone numbers and calls handled differently based on the variables described above. For example, users with high technical ratings could reach higher-tier technical operators; users with high Klout (a measurement of social media influence) scores could receive priority queuing with companies; users with many Twitter or Facebook followers could receive priority queuing; users with high karma (for example an internal score of many factors) could receive higher priority; users with high friendliness scores might receive higher priority.

Scripts may be employed to to display step by step instructions to the user. If a user needs help, they can click a button and customer service will contact them according to FIG. 1. The call is navigated to the right agent based on where they got in the script. Transmitted to the agent is what step the user was on with the script, thereby saving the company and the user hold time.

Voice, data, and both can be employed. For voice, the call to the company is placed as already disclosed. When the agent answers the call, an audio message is played telling them where the user is on the script. This can be done by way of text-to-voice. When the agent is ready, they press 1, as disclosed and with the addition of passing data by voice. For data, a company's API may be used to communicate data with the call

An embedded QR code reader to recognize a QR code may, look up the code in a local or online database, and trigger a call from that company to the user. For example, a user purchases a Sanyo DVD player. The user unpacks it, connect everything but cannot get it to work. Instead of looking around for the 800-number, the user point their camera of their mobile phone at the QR code. The application recognize the product and/or company and places the call, as disclosed above, in part or in whole. In another example, a user of the application points the camera at the name of a company, and if the company's name is in the database, the call is place as disclosed above, in part or in whole. In yet another example, the camera is directed to a number, such as an 800 number. By way of voice recognition, a user can speak the name of a company to trigger the call. Or a text message can be sent by the user to the server to trigger the call.

The methods and systems may be implemented on any computer communicating over any network. For example the computers may include desktop computers, tablets, handheld devices, laptops and mobile devices. The mobile devices may comprise many different types of mobile devices such as cell phones, smart phones, PDAs, portable computers, tablets, and any other type of mobile device operable to transmit and receive electronic messages.

The computer network(s) may include the internet and wireless networks such as a mobile phone network. Any reference to a “computer” is understood to include one or more computers operable to communicate with each other. Computers and devices comprise any type of computer capable of storing computer executable code and executing the computer executable code on a microprocessor, and communicating with the communication network(s). For example computer may be a web server.

References to electronic identifiers may be used which include, but are not limited to, email addresses, mobile phone numbers, user IDs for instant messaging services, user IDs for social networking application or mobile applications, user IDs and URLs for blogs and micro-blogs, URIs, bank account or financial institution numbers, routing numbers, credit and debit cards, any computer readable code, and other electronic identifiers to identify accounts, users, companies, and the like.

The systems and methods may be implemented on an Intel or Intel compatible based computer running a version of the Linux operating system or running a version of Microsoft Windows, Apple OS, and other operating systems. Computing devices based on non-Intel processors, such as ARM devices may be used. Various functions of any server, mobile device or, generally, computer may be implemented in hardware and/or in software, including in one or more signal processing and/or application specific integrated circuits.

The computers and, equivalently, mobile devices may include any and all components of a computer such as storage like memory and magnetic storage, interfaces like network interfaces, and microprocessors. For example, a computer comprises some of all of the following: a processor in communication with a memory interface (which may be included as part of the processor package) and in communication with a peripheral interface (which may also be included as part of the processor package); the memory interface is in communication via one or more buses with a memory (which may be included, in whole or in part, as part of the processor package; the peripheral interface is in communication via one or more buses with an input/output (I/O) subsystem; the I/O subsystem may include, for example, a graphic processor or subsystem in communication with a display such as an LCD display, a touch screen controller in communication with a touch sensitive flat screen display (for example, having one or more display components such as LEDs and LCDs including sub-types of LCDS such as IPS, AMOLED, S-IPS, FFS, and any other type of LCD; the I/O subsystem may include other controllers for other I/O devices such as a keyboard; the peripheral interface may be in communication with either directly or by way of the I/O subsystem with a storage controller in communication with a storage device such a hard drive, non-volatile memory, magnetic storage, optical storage, magneto-optical storage, and any other storage device capable of storing data; the peripheral interface may also be in communication via one or more buses with one or more of a location processor such as a GPS and/or radio triangulation system, a magnetometer, a motion sensor, a light sensor, a proximity sensor, a camera system, wireless communication subsystem(s), and audio subsystems.

A non-transitory computer readable medium, such as the memory and/or the storage device(s) includes/stores computer executable code which when executed by the processor of the computer causes computer to perform a series of steps, processes, or functions. The computer executable code may include, but is not limited to, operating system instructions, communication instruction, GUI (graphical user interface) instructions, sensor processing instructions, phone instructions, electronic messaging instructions, web browsing instructions, media processing instructions, GPS or navigation instructions, camera instructions, magnetometer instructions, calibration instructions, an social networking instructions.

An application programming interface (API) permits the systems and methods to operate with other software platforms such as Salesforce CRM, Google Apps, Facebook, Twitter, social networking sites, desktop and server software, web applications, mobile applications, and the like. For example, an interactive messaging system could interface with CRM software and GOOGLE calendar.

A computer program product may include a non-transitory computer readable medium comprising computer readable code which when executed on the computer causes the computer to perform the methods described herein. Databases may comprise any conventional database such as an Oracle database or an SQL database. Multiple databases may be physically separate, logically separate, or combinations thereof.

The features described can be implemented in any digital electronic circuitry, with a combination of digital and analogy electronic circuitry, in computer hardware, firmware, software, or in combinations thereof. The features can be implemented in a computer program product tangibly embodied in an information carrier (such as a hard drive, solid state drive, flash memory, RAM, ROM, and the like), e.g., in a machine-readable storage device or in a propagated signal, for execution by a programmable processor; and method steps can be performed by a programmable processor executing a program of instructions to perform functions and methods of the described implementations by operating on input data and generating output(s).

The described features can be implemented in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any type of programming language (e.g., Objective-C, Java), including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. Some elements of a computer are a processor for executing instructions and one or more memories for storing instructions and data. Generally, a computer will also include, or communicate with one or more mass storage devices for storing data files. Exemplary devices include magnetic disks such as internal hard disks and removable disks, magneto-optical disks, and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) for displaying information to the user and a keyboard and a pointing device such as a mouse or a trackball by which the user can provide input to the computer. The display may be touch sensitive so the user can provide input by touching the screen.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, wired and wireless packetized networks, and the computers and networks forming the Internet.

The foregoing detailed description has discussed only a few of the many forms that this invention can take. It is intended that the foregoing detailed description be understood as an illustration of selected forms that the invention can take and not as a definition of the invention. It is only the claims, including all equivalents, that are intended to define the scope of this invention.

What is claimed is:

1. A one-click method for contacting a person comprising the steps of selecting a company; and receiving a call from the company.
